(19) United States
(12) Patent Application Publication
(10) Pub. No.: US 2026/0052253 A1
(43) Pub. Date: Feb. 19, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Ke MA, Beijing (CN); Yaojun WU, Beijing (CN); Zhaobin ZHANG, Los Angeles, CA (US); Semih ESENLIK, Los Angeles, CA (US); Kai ZHANG, Los Angeles, CA (US); Li ZHANG, Los Angeles, CA (US)

(21) Appl. No.: 19/347,454

(22) Filed: Oct. 1, 2025

Related U.S. Application Data
(63) Continuation of application No. PCT/CN2024/085314, filed on Apr. 1, 2024.

(30) Foreign Application Priority Data
Apr. 1, 2023 (WO) PCT/CN2023/085816

(51) Int. Cl. H04N 19/132; H04N 19/169; H04N 19/63

(52) U.S. Cl. CPC H04N 19/132; H04N 19/1883; H04N 19/63

(57) ABSTRACT

Embodiments of the present disclosure provide a solution for visual data processing. A method for visual data processing is proposed. The method comprises: obtaining, for a conversion between visual data and a bitstream of the visual data with a neural network (NN)-based model, at least one subband in a plurality of subbands associated with a wavelet-based transform on the visual data; coding a first sample of a first subband in the plurality of subbands based on the at least one subband that is different from the first subband; and performing the conversion based on the coded first sample.

### CROSS REFERENCE TO RELATED APPLICATIONS

This application is a continuation of International Application No. PCT/CN2024/085314, filed on Apr. 1, 2024, which claims the benefit of International Application No. PCT/CN2023/085816, filed on Apr. 1, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding quality of neural network-based image/video coding is generally expected to be further improved.

### SUMMARY

Embodiments of the present disclosure provide a solution for visual data processing.

In a first aspect, a method for visual data processing is proposed. The method comprises: obtaining, for a conversion between visual data and a bitstream of the visual data with a neural network (NN)-based model, at least one subband in a plurality of subbands associated with a wavelet-based transform on the visual data; coding a first sample of a first subband in the plurality of subbands based on the at least one subband that is different from the first subband; and performing the conversion based on the coded first sample.

According to the method in accordance with the first aspect of the present disclosure, a subband in a plurality of subbands associated with a wavelet-based transform on the visual data is coded based on at least one further subband in the plurality of subbands. Compared with the conventional solution where each of the plurality of subbands is coded independently, the proposed method can advantageously utilize the cross-subband information, and thus the coding quality can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: obtaining at least one subband in a plurality of subbands associated with a wavelet-based transform on the visual data; coding a first sample of a first subband in the plurality of subbands based on the at least one subband that is different from the first subband; and generating the bitstream with a neural network (NN)-based model based on the coded first sample.

In a fifth aspect, a method for storing a bitstream of visual data is proposed. The method comprises: obtaining at least one subband in a plurality of subbands associated with a wavelet-based transform on the visual data; coding a first sample of a first subband in the plurality of subbands based on the at least one subband that is different from the first subband; generating the bitstream with a neural network (NN)-based model based on the coded first sample; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example encoder and decoder with wavelet-based transform;

FIG. 8 illustrates an example output of a forward wavelet-based transform;

FIG. 9 illustrates an example partitioning of the output of a forward wavelet-based transform;

FIG. 10 illustrates an example coding structure in accordance with some embodiments of the present disclosure;

FIG. 11 illustrates an example coding process in accordance with some embodiments of the present disclosure;

FIG. 12A illustrates some example sub-networks utilized in the coding process in accordance with some embodiments of the present disclosure;

FIG. 12B illustrates some further example sub-networks utilized in the coding process in accordance with some embodiments of the present disclosure;

FIG. 13 illustrates a flowchart of a method for visual data processing in accordance with some embodiments of the present disclosure;

FIG. 14 illustrates an example coding structure for a case where a parsing process and an entropy probability modeling process are coupled;

FIG. 15 illustrates another example coding structure for a case a parsing process and an entropy probability modeling process are decoupled; and

FIG. 16 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

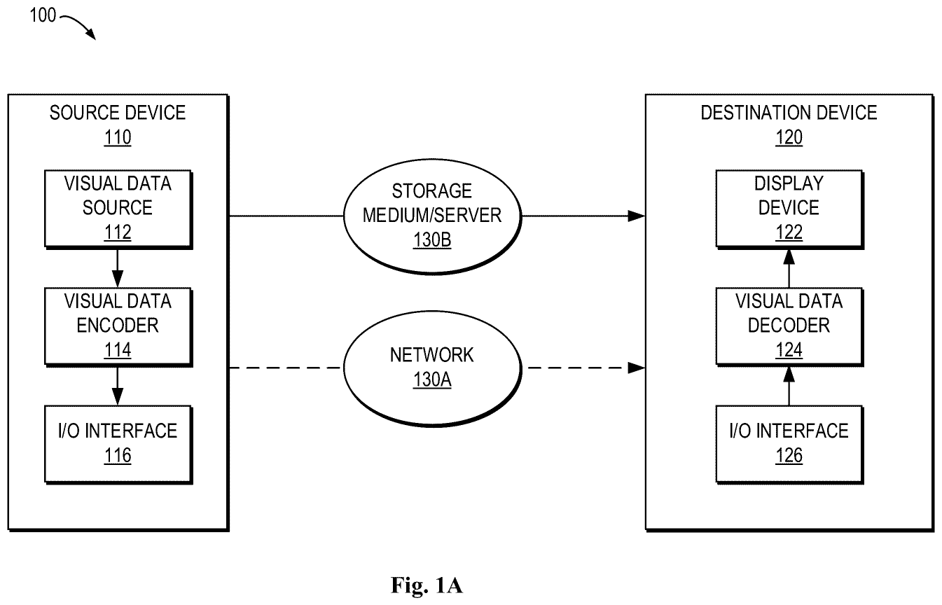

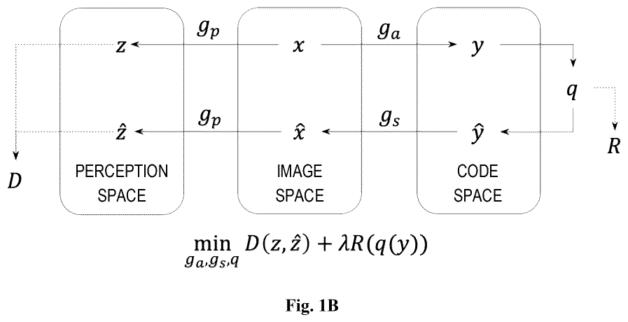

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Initial Discussion

This patent document is related to a neural network-based image and video lossless compression method, wherein a wavelet-like transform and decoupled entropy model are combined to boost the coding performance and efficiency. The design targets the problem to compress the sub-bands obtained by the wavelet-like transformation losslessly with a decoupled entropy model where the context model, quantization model, and hyper decoder need to be well designed.

### 2. Further Discussion

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks for Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as −log₂ p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit −log₂ p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R,G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(x) given a context x₁, x₂, . . . , xᵢ₋₁.

Most of the methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 2.3.2 Auto-Encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

FIG. 1B is a schematic diagram illustrating an example transform coding scheme. The original image x is transformed by the analysis network gₐ to achieve the latent representation y. The latent representation y is quantized (q) and compressed into bits. The number of bits R is used to measure the coding rate. The quantized latent representation y is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme can be regarded as a transform coding strategy. The original image x is transformed with the analysis network y=gₐ(x), where y is the latent representation to be quantized and coded. The synthesis network inversely transforms the quantized latent representation ŷ back to obtain the reconstructed image \hat{x}=gₛ(ŷ). The framework is trained with the rate-distortion loss function, [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

### 2.3.3 Hyper Prior Model

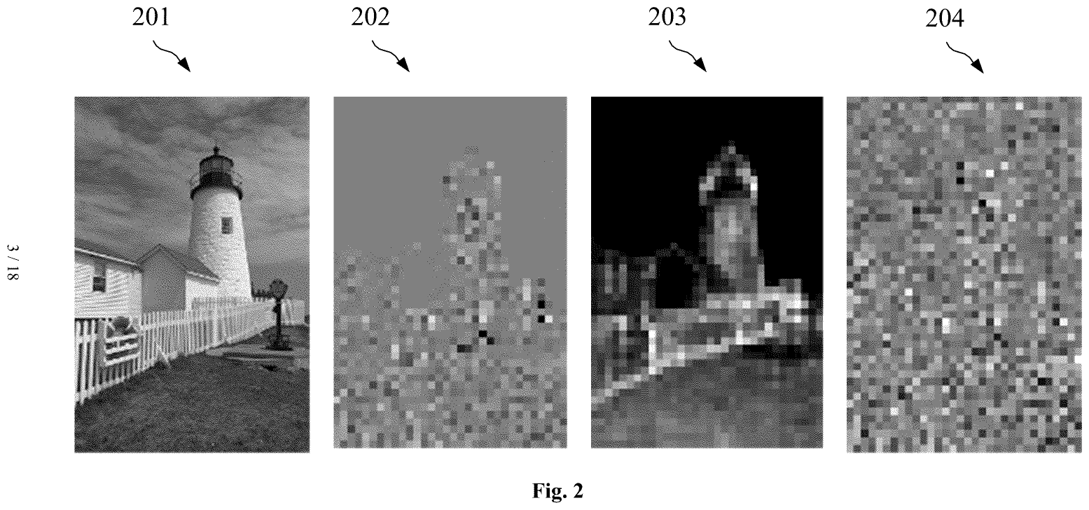

FIG. 2 illustrates example latent representations of an image. FIG. 2 includes an image 201 from the Kodak dataset, va isualization of the latent 202 representation y of the image 201, a standard deviations σ 203 of the latent 202, and latents y 204 after a hyper prior network is introduced. A hyper prior network includes a hyper encoder and decoder. In the transform coding approach to image compression, as shown in FIG. 1B, the encoder subnetwork transforms the image vector x using a parametric analysis transform gₐ(x,527 _{g}) into a latent representation y, which is then quantized to form ŷ. Because ŷ is discrete-valued, ŷ can be losslessly compressed using entropy coding techniques such as arithmetic coding and transmitted as a sequence of bits.

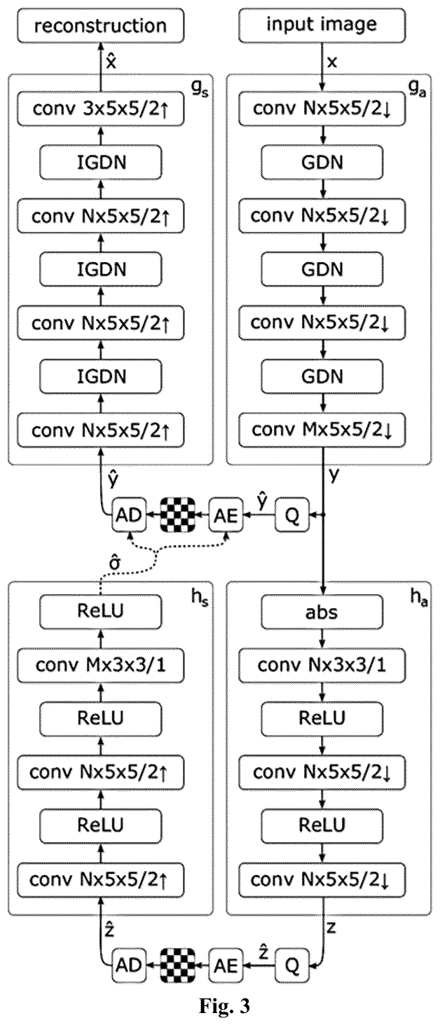

As evident from the latent 202 and the standard deviations σ 203 of FIG. 2, there are significant spatial dependencies among the elements of ŷ. Notably, their scales (standard deviations σ 203) appear to be coupled spatially. An additional set of random variables \hat{z} may be introduced to capture the spatial dependencies and to further reduce the redundancies. In this case the image compression network is depicted in FIG. 3.

FIG. 3 is a schematic diagram illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In FIG. 3, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 204 in FIG. 2 correspond to the quantized latent when the hyper encoder/decoder are used. Compared to the standard deviations σ 203, the spatial redundancies are significantly reduced as the samples of the quantized latent are less correlated.

### 2.3.4 Context Model

Although the hyper prior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process. For example, the context model subnetwork generates one sample of a latent, which is later used as input to obtain the next sample.

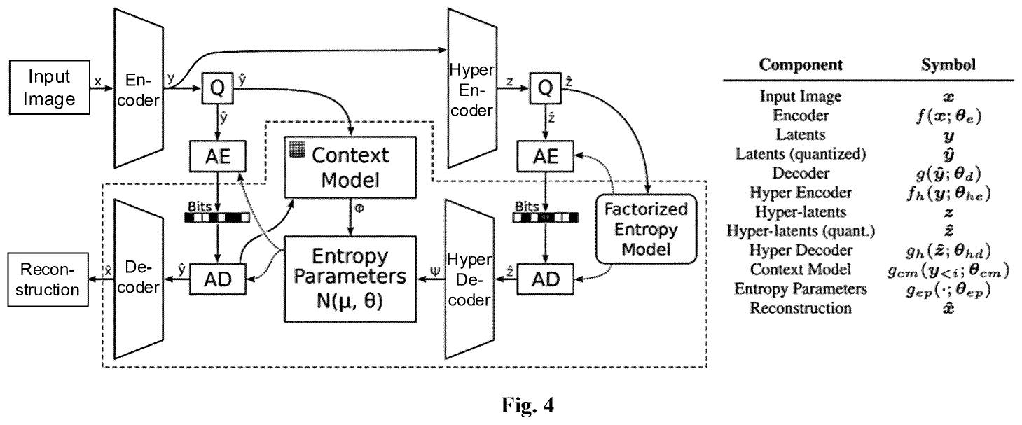

FIG. 4 is a schematic diagram illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

In an example, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c·h·w}, where c, h, w represent the number of channels, the height and width of the latent representation. Each channel of the latent representation is denoted as y₍ᵢ₎ ∈R^{h·w}, where i=0, 1, . . . , c−1. A pair of gain units include a gain matrix M∈R^{c·n} and an inverse gain matrix, where n is the number of gain vectors. The gain vector can be denoted as mₛ={αₛ₍₀₎,αₛ₍₁₎, . . . ,α_{s(c-1)}}, αₛ₍ᵢ₎ ∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c·n}, which includes n inverse gain vectors, i.e., M′={δₛ₍₀₎,δₛ₍₁₎, . . . ,δ_{s(c-1)}}, δₛ₍ᵢ₎ ∈R. The inverse gain process is expressed as:

$${y}_{s}^{′} = \hat{y} ⊙ {m}_{s}^{′}$$

where ŷ is the decoded quantized latent representation and

$${y}_{s}^{′}$$

is the inversely gained quantized latent representation, which will be fed into the synthesis network.

To achieve continuous variable rate adjustment, interpolation is used between vectors. Given two pairs of gain vectors

$$\{ {m}_{t} , {m}_{t}^{′} \}$$

and

$$\{ {m}_{r} , {m}_{r}^{′} \} ,$$

the interpolated gain vector can be obtained via the following equations:

$${m}_{v} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 the Encoding Process Using Joint Auto-Regressive Hyper Prior Model

The design in FIG. 4. corresponds an example combined compression method. In this section and the next, the encoding and decoding processes are described separately.

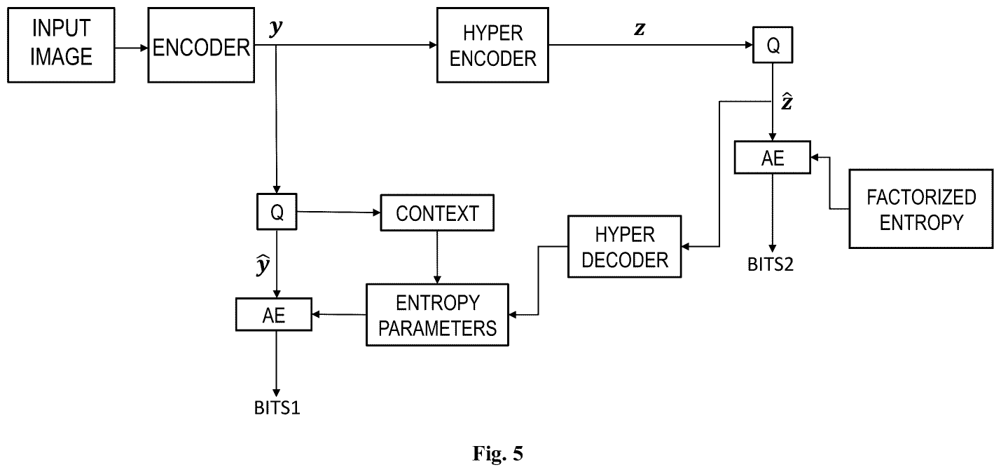

FIG. 5 illustrates an example encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or \tilde{y}[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all of the elements in FIG. 5 are collectively called an encoder. The analysis transform that converts the input image into latent representation is also called an encoder (or auto-encoder).

### 2.3.7 the Decoding Process Using Joint Auto-Regressive Hyper Prior Model

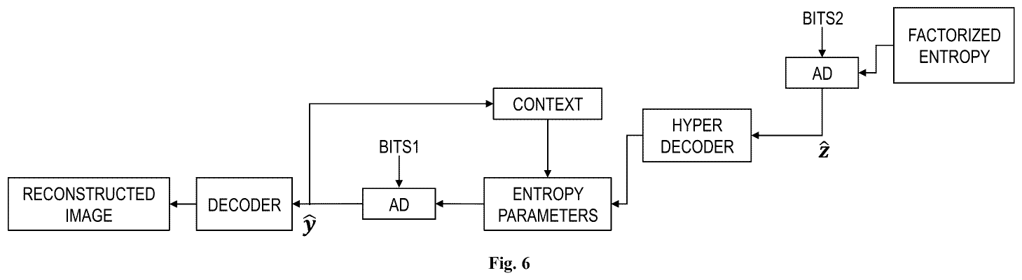

FIG. 6 illustrates an example decoding process. FIG. 6 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent 2 that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.3.8 Wavelet Based Neural Compression Architecture

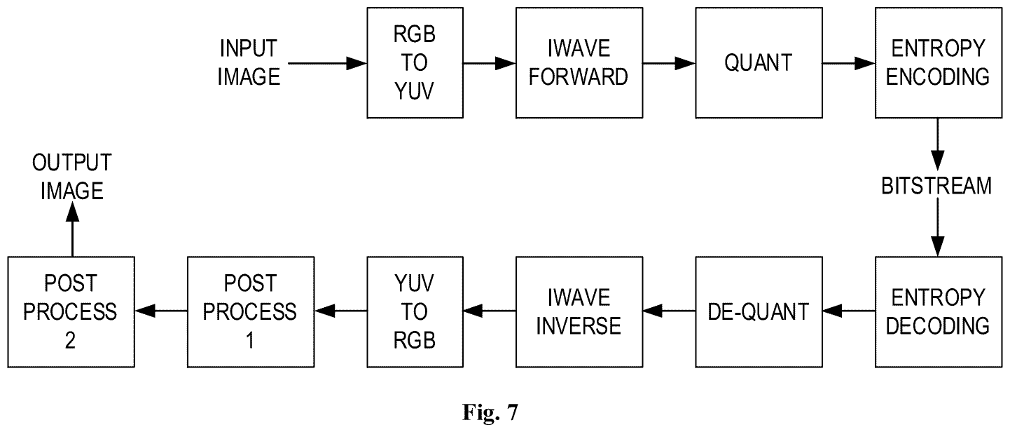

The analysis transform (denoted as encoder) in FIG. 5 and the synthesis transform (denoted as decoder) in FIG. 6 might be replaced by a wavelet-based neural network transform. FIG. 7 illustrates an example encoder and decoder with wavelet-based transform. For example, FIG. 7. shows an example of image compression framework with wavelet-based neural network transform. In the figure first the input image is converted from an RGB color format to a YUV color format. This conversion process is optional, which may be missing in other implementations. If such a conversion is applied to the input image, an inverse conversion (from YUV to RGB) is also applied to the reconstructed image. The core of an encoder with wavelet-based transform comprises a wavelet-based forward transform, a quantization module, and an entropy coding module, which compress the raw images into bitstreams. The core of the decoding process is composed of entropy decoding, de-quantization process and an inverse wavelet-based transform operation. The decoding process convers the bitstream into output image. Similar to the color space conversion, the two postprocessing units shown in FIG. 7 are also optional, which can be removed in some implementations.

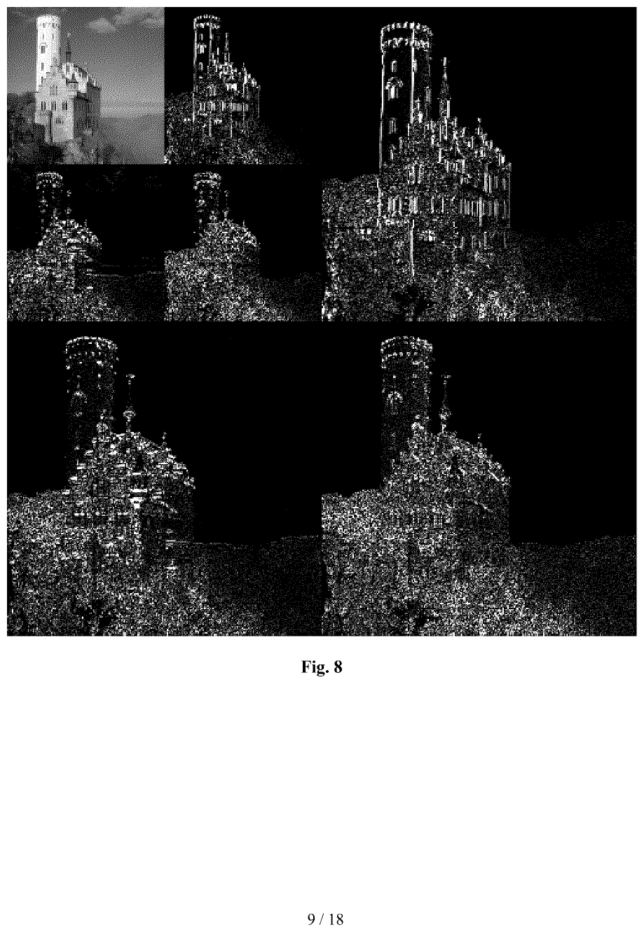

After the wavelet-based transform (denoted as iWave forward in FIG. 7), the image is decomposed into high frequency (details) and low frequency (approximation). In each level, there are 4 sub-bands, namely the LL, LH, HH, HL sub-bands. Multiple levels of wavelet-based transforms can be applied. For example, the LL sub-band from the first level decomposition can be further decomposed with another wavelet-based transform, resulting 7 sub-bands in total, as shown in FIG. 8. The input of the transform is an image of a castle. In the example, after the transform an output with 7 distinct regions are obtained. The number of sub-bands is decided by the number of wavelet-based transforms that are applied to the images. The number of sub-bands Nₛ can be expressed as follows:

$${N}_{s} = 3 \times N + 1$$

where N denotes the number (levels) of wavelet-based transforms.

FIG. 8 illustrates an example output of a forward wavelet-based transform. In FIG. 8, one can see that the input image is transformed into 7 regions with 3 small images and 4 even smaller images. The transformation is based on the frequency components, the small image at the bottom right quarter comprises the high frequency components in both horizontal and vertical directions. The smallest image at the top-left corner on the other hand comprises the lowest frequency components both in the vertical and horizontal directions. The small image on the top-right quarter comprises the high frequency components in the horizontal direction and low frequency components in the vertical direction.

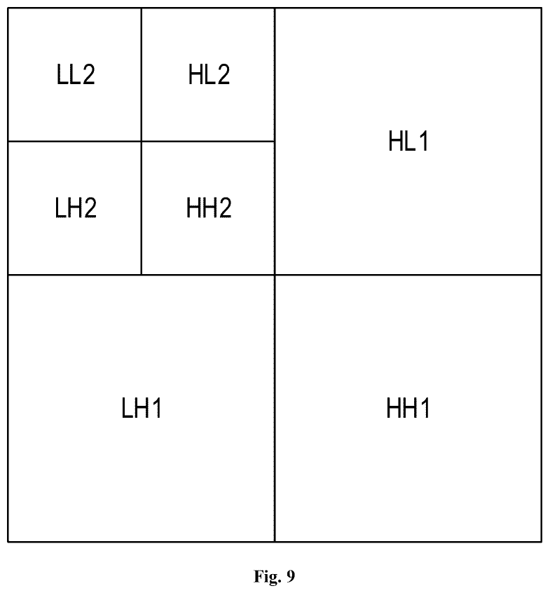

FIG. 9 illustrates an example partitioning of the output of a forward wavelet-based transform. FIG. 9 depicts a possible splitting of the latent representation after the 2D forward transform. The latent representation are the samples (latent samples, or quantized latent samples) that are obtained after the 2D forward transform. The latent samples are divided into 7 sections above, denoted as HH1, LH1, HL1, LL2, HL2, LH2 and HH2. The HH1 describes that the section comprises high frequency components in the vertical direction, high frequency components in the horizontal direction and that the splitting depth is 1. HL2 describes that the section comprises low frequency components in the vertical direction, high frequency components in the horizontal direction and that the splitting depth is 2.

After the latent samples are obtained at the encoder by the forward wavelet transform, they are transmitted to the decoder by using entropy coding. At the decoder, entropy decoding is applied to obtain the latent samples, which are then inverse transformed (by using iWave inverse module in FIG. 7.) to obtain the reconstructed image.

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.5 Preliminaries

Almost all the natural image and/or video is in digital format. A grayscale digital image can be represented by x∈ [symbol] ^{m×n}, where D is the set of values of a pixel, m is the image height, and n is the image width. For example, [symbol] ={0, 1, 2, . . . ,255} is an example setting, and in this case | [symbol] D|=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference choma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀,x₁, . . . ,xₜ, . . . ,x_{T-1}} where T is the number of frames in a video sequence and x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{‖ x - \hat{x} {‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 3. Technical Problems Solved by Disclosed Technical Solutions

Learning-based wavelet-like transformation has achieved superior performance in learning-based image compression due to its capability to support both lossy and lossless compression. For further performance and efficiency improvement in lossless compression, the combination of wavelet-like transformation and decoupled entropy model is a potential topic. However, directly feeding lossless sub-bands obtained by wavelet-like transformation to decoupled entropy model still seems to have some problems. It is known that in the decoupled entropy model, a distribution is built to describe the probability of the input feature, whose parameters used for prediction need to be quantized in lossless compression task. How to properly quantize the parameters of the distribution and fully utilize the context information of different sub-bands is still an essential issue.

### 4. a Listing of Solutions and Embodiments

To solve the problem and some other problems not mentioned, methods as summarized below are disclosed. Specifically, this design includes a solution on the Encoder and Decoder side to efficiently realize the combination of the wavelet-based transformation and transformer-based entropy model. More detailed information is disclosed below.

Encoder: A method of converting an input image to bitstream by application of following steps:
Transforming an input image using a wavelet-like transform, wherein the output comprises at least two subbands;
Obtaining the bitstream by applying entropy coding to the said subbands.

Decoder: A method of converting a bitstream to reconstructed image by application of following steps:
Obtaining at least two subbands by application of entropy decoding on the bitstream;
Transforming the subbands using a wavelet-like transformation.

Details of the at least two subbands:
The subbands might have the approximate sizes of:

$$\frac{W}{2} \times \frac{H}{2} and \frac{W}{4} \times \frac{H}{4} ,$$

$$\frac{W}{2} \times \frac{H}{2} and \frac{W}{4} \times \frac{H}{4} , \frac{W}{8} \times \frac{H}{8} ,$$

$$\frac{W}{2} \times \frac{H}{2} and \frac{W}{4} \times \frac{H}{4} , \frac{W}{8} \times \frac{H}{8} , \frac{W}{16} \times \frac{H}{16} ,$$

wherein the H and W relate to the size of the input image or the reconstructed image, and the number of the subbands is dependent on the transformation times of the wavelet.
In an example, the H might be the height of the input image or the reconstructed image.
In another example, the W might be the width of the input image or the reconstructed image.

Details of the entropy coding module:
The entropy coding module might contain a hyper prior structure.
The entropy coding module might contain a context model.
   The context model might be performed by a neural network.
      The neural network used to exact context information might comprise any of the following:
         A deconvolution layer,
         A convolution layer,
         A masked convolution layer,
         A residual block,
         An activation layer,
         A leaky relu layer,
         A relu layer.
   The context model might be performed just on one certain sub-band.
   The context model might be performed on some of the sub-bands.
   The context model might be performed by according to a target size.
      In one example the context sub-bands' size might be equal to the size of the sub-band which is being encoded.
      In an example target size might be equal to

$$\frac{W}{2} \times \frac{H}{2} , or \frac{W}{4} \times \frac{H}{4} , or \frac{W}{8} \times \frac{H}{8} , or \frac{W}{16} \times \frac{H}{16} .$$

### 5. Further Details

Given that N levels of wavelet-like forward transformations are applied to the input image, a group of sub-bands with N spatial sizes are generated. Taking N=4 as an example, the latent samples are divided into 13 sections, denoted as HH1, LH1, HL1, HH2, LH2, HL2, HH3, LH3, HL3, LL4, HL4, LH4 and HH4. These 13 sections might belong to four spatial resolutions as follows:

$$\frac{W}{2} \times \frac{H}{2} : LH 1 , HH 1 , HL 1 ,$$

$$\frac{W}{4} \times \frac{H}{4} : LH 2 , HH 2 , HL 2 ,$$

$$\frac{W}{8} \times \frac{H}{8} : LH 3 , HH 3 , HL 3 ,$$

$$\frac{W}{16} \times \frac{H}{16} : LH 4 , HH 4 , HL 4 , LL 4 ,$$

where W×H is the spatial size (width and height respectively) of the input of the forward wavelet-based transform.

The techniques describe herein provide a method that is utilized in the combination of learning-based wavelet-like transformation and non-linear entropy model in lossless image compression. The designed network is applied to the output subbands after wavelet-like forward transformation. To obtain the bitstream, specific non-linear transformation structure is designed in this application.

(1) In summary, the design of the encoder includes the following features:

For subbands that obtained after the wavelet-like transformation, all subbands might be fed to the entropy model to obtain bitstream. The operation might be designed in one or more of the following approaches:
a. In one example, a gaussian distribution will be used to model the probability of the lossless wavelet sub-bands. Specifically, the mean and variance of the distribution will be obtained based on the aforementioned entropy model:
   i. In one example, to decouple the parsing and entropy probability modeling process, the obtained mean and variance are not only simply used in probability model. The obtained residual value after subtracting the mean value from the input sub-bands will be encoded to bitstream by auto-encoder.
      1. In one example, in lossless image compression task, the integer sub-bands are obtained after a 5/3 wavelet transformation. As a result, the mean value may be quantized so that the residual sub-bands can be encoded.
         a. In one example, the round function is used in mean value quantization. The quantization value will be the nearest integer of the input value.
         b. In one example, a scale parameter can be applied to the mean value quantization, which can control the step of the quantization adaptively.
      2. In one example, to process 13 sub-bands of four different spatial resolutions after four levels of 5/3 wavelet transformation, the hyper analysis transformation needs to be finely designed.
         a. In one example, the weights in hyper analysis transformation are shared, considering that hyper analysis transformation have similar function and operation on different subbands. The weight of the block processing small sub-bands will be reused in the processing of larger sub-bands.
         b. In one example, a scale parameter can be applied to the quantization of mean value, which can control the step of the quantization adaptively.
   ii. Alternatively, the parsing and entropy probability modeling process are not decoupled. The obtained mean and variance are directly used in probability model.
      1. In one example, to process 13 sub-bands of four different spatial resolutions after four levels of 5/3 wavelet transformation, the hyper analysis transformation needs to be finely designed.
         a. In one example, the weights in hyper analysis transformation are shared, considering that hyper analysis transformation have similar function and operation on different subbands. The weight of the block processing small sub-bands will be reused in the processing of larger sub-bands.
         b. In one example, a scale parameter can be applied to the mean value quantization, which can control the step of the quantization adaptively.
b. In one example, a gaussian mixture model is utilized in entropy model containing N gaussian distributions to model the probability of the lossless wavelet sub-bands. Taking N=3 as an example, three means and variances of the distributions will be obtained based on the aforementioned entropy model:
   i. In one example, to decouple the parsing and entropy probability modeling process, the obtained mean and variance are not only simply used in probability model. The obtained residual value after subtracting the average/weighted mean value from the input sub-bands will be encoded to bitstream by auto-encoder.
      1. In one example, the average mean value will be calculated by the average of the obtained N mean values.
      2. Alternatively, the weighted mean will be calculated to obtain the residual information, and weights might be derived from the entropy model.
      3. In one example, in lossless image compression task, the integer sub-bands are obtained after a 5/3 wavelet transformation. As a result, the mean value should be quantized so that the residual sub-bands can be encoded.
         a. In one example, the round function is used in mean value quantization. The quantization value will be the nearest integer of the input value.
         b. In one example, a scale parameter can be applied to the mean value quantization, which can control the step of the quantization adaptively.
      2. In one example, to process 13 sub-bands of four different spatial resolutions after four levels of 5/3 wavelet transformation, the hyper analysis transformation needs to be finely designed.
         a. In one example, the weights in hyper analysis transformation are shared, considering that hyper analysis transformation have similar function and operation on different subbands. The weight of the block processing small sub-bands will be reused in the processing of larger subbands.
         b. In one example, a scale parameter can be applied to the mean value quantization, which can control the step of the quantization adaptively.
   ii. Alternatively, the parsing and entropy probability modeling process are not decoupled. The obtained mean and variance are directly used in probability model.
      1. In one example, to process 13 sub-bands of four different spatial resolutions after four levels of 5/3 wavelet transformation, the hyper analysis transformation needs to be finely designed.
         a. In one example, the weights in hyper analysis transformation are shared, considering that hyper analysis transformation have similar function and operation on different subbands. The weight of the block processing small sub-bands will be reused in the processing of larger subbands.
         b. In one example, the weights in hyper analysis are independent. Different operation can be applied to the sub-bands of different spatial resolutions.
c. In one example most of the structure usually used in wavelet-like-transform-based end-to-end image compression will be retained. The probability model used to encode sub-band based on its context information will be replaced by a model extensively used in non-linear-based decoupled probability model.
   i. In one example, the context model used for the first subband to be encoded (LLD) is a pure pixel-CNN with masked convolution which only utilizes the correlation inside the first sub-band. For other sub-bands, besides using the previously processed coefficients in the same sub-band, the context model also uses the coefficients from the previously processed sub-bands. This is achieved by introducing a long-term context Lt. For example, when processing HL3, LL3 is used as Lt. When processing LH3, {LL3, HL3} are stacked and then used as Lt. When processing HH3, {LL3, HL3, LH3} are stacked and then used as Lt.
      1. In one example, all the sub-bands of the same level are used.
      2. In one example, only certain sub-bands of the same level are used.
   ii. In one example, the channel-level auto-regression is added to context model to accelerate the coding process. In the main structure of mixed auto-regressive entropy model, only LL sub-band does pixel-level auto-regression. Meanwhile LL sub-band is the context for HL sub-band, the channel-level auto-regression is applied on LL. Similarly, while processing LH, LL and HL are utilized as context. After finishing one stage, all the sub-bands will do bicubic up-sample and be the context for sub-bands in last stage.
      1. In one example, all the sub-bands of the same level are used.
      2. In one example, only certain sub-bands of the same level are used.

(2) As the inverse operation of the decoder, an example of the decoder includes the following features:

For bitstreams that obtained after the encoder, all subbands might be fed to the entropy decoder to reconstruct the input images. The operation might be designed in one or more of the following approaches:
a. In one example, a gaussian distribution will be used to model the probability of the lossless wavelet sub-bands. Specifically, the mean and/or the variance of the distribution will be obtained based on the aforementioned entropy model:
   i. In one example, to decouple the parsing and entropy probability modeling process, the obtained mean and variance are not only simply used in probability model. The obtained residual value after subtracting the mean value from the input sub-bands will be encoded to bitstream by auto-encoder.
      1. In one example, in lossless image compression task, the integer sub-bands are obtained after a 5/3 wavelet transformation. As a result, the mean value should be quantized so that the residual sub-bands can be encoded.
         a. In one example, the round function is used in mean value quantization. The quantization value will be the nearest integer of the input value.
         b. In one example, a scale parameter can be applied to the mean value quantization, which can control the step of the quantization adaptively.
      2. In one example, to process 13 sub-bands of four different spatial resolutions after four levels of 5/3 wavelet transformation, the hyper analysis transformation needs to be finely designed.
         a. In one example, the weights in hyper decoder are shared, considering that hyper decoder have similar function and operation on different sub-bands. The weight of the block processing small sub-bands will be reused in the processing of larger subbands.
         b. In one example, the weights in hyper decoders are independent. Different operation can be applied to the sub-bands of different spatial resolutions.
      3. In one example, to process 13 sub-bands of four different spatial resolutions after four levels of 5/3 wavelet transformation, context information should be exacted from the sub-bands.
         a. In one example, the context information is obtained after ŷ is processed by a pixel-CNN model.
         b. In one example, the context information is exacted not only from ŷ, but also from the encoded subbands.
         i In one example, the context model used for the first sub-band to be encoded (LLD) is a pure pixel-CNN with masked convolution which only utilizes the correlation inside the first sub-band. For other sub-bands, besides using the previously processed coefficients in the same sub-band, the context model also uses the coefficients from the previously processed sub-bands.
         ii In one example, in one example, the channel-level auto-regression is added to context model to accelerate the coding process. In the main structure of mixed auto-regressive entropy model, only LL sub-band does pixel-level auto-regression. Meanwhile LL sub-band is the context for HL sub-band, the channel-level auto-regression is applied on LL. Similarly, while processing LH, LL and HL are utilized as context.
   ii. Alternatively, the parsing and entropy probability modeling process are not decoupled. The obtained mean and variance are directly used in probability model.
      1. In one example, to process 13 sub-bands of four different spatial resolutions after four levels of 5/3 wavelet transformation, the hyper decoder needs to be finely designed.
         a. In one example, the weights in hyper decoder are shared, considering that hyper decoder have similar function and operation on different sub-bands. The weight of the block processing small sub-bands will be reused in the processing of larger subbands.
         b. In one example, the weights in hyper decoders are independent. Different operation can be applied to the sub-bands of different spatial resolutions.
b. In one example, a gaussian mixture model is utilized in entropy model containing N gaussian distributions to model the probability of the lossless wavelet sub-bands. Taking N=3 as an example Three means and variances of the distributions will be obtained based on the aforementioned entropy model:
   i. In one example, to decouple the parsing and entropy probability modeling process, the obtained mean and variance are not only simply used in probability model. The obtained residual value after subtracting the mean value from the input sub-bands will be encoded to bitstream by auto-encoder.
      1. In one example, in lossless image compression task, the integer sub-bands are obtained after a 5/3 wavelet transformation. As a result, the mean value should be quantized so that the residual sub-bands can be encoded.
         a. In one example, the round function is used in mean value quantization. The quantization value will be the nearest integer of the input value.
         b. In one example, a scale parameter can be applied to the mean value quantization, which can control the step of the quantization adaptively.
      2. In one example, to process 13 sub-bands of four different spatial resolutions after four levels of 5/3 wavelet transformation, the hyper analysis transformation needs to be finely designed.
         a. In one example, the weights in hyper analysis transformation are shared, considering that hyper analysis transformation have similar function and operation on different subbands. The weight of the block processing small sub-bands will be reused in the processing of larger subbands.
         b. In one example, the weights in hyper decoders are independent. Different operation can be applied to the sub-bands of different spatial resolutions.
   ii. Alternatively, the parsing and entropy probability modeling process are not decoupled. The obtained mean and variance are directly used in probability model.
      2. In one example, to process 13 sub-bands of four different spatial resolutions after four levels of 5/3 wavelet transformation, the hyper decoder needs to be finely designed.
         a. In one example, the weights in hyper decoder are shared, considering that hyper analysis transformation have similar function and operation on different subbands. The weight of the block processing small sub-bands will be reused in the processing of larger subbands.
         b. In one example, the weights in hyper decoders are independent. Different operation can be applied to the sub-bands of different spatial resolutions.
c. In one example most of the structure usually used in wavelet-like-transform-based end-to-end image compression will be retained. The probability model used to encode sub-band based on its context information will be replaced by a model extensively used in non-linear-based decoupled probability model.
   i. In one example, the context model used for the first subband to be encoded (LLD) is a pure pixel-CNN with masked convolution which only utilizes the correlation inside the first subband. For other subbands, besides using the previously processed coefficients in the same subband, the context model also uses the coefficients from the previously processed subbands. This is achieved by introducing a long-term context Lt. For example, when processing HL3, LL3 is used as Lt. When processing LH3, {LL3, HL3} are stacked and then used as Lt. When processing HH3, {LL3, HL3, LH3} are stacked and then used as Lt.
      1. In one example, all the sub-bands of the same level are used.
      2. In one example, only certain sub-bands of the same level are used.
   ii. In one example, the channel-level auto-regression is added to context model to accelerate the coding process. In the main structure of mixed auto-regressive entropy model, only LL sub-band does pixel-level auto-regression. Meanwhile LL sub-band is the context for HL sub-band, the channel-level auto-regression is applied on LL. Similarly, while processing LH, LL and HL are utilized as context. After finishing one stage, all the sub-bands will do bicubic up-sample and be the context for sub-bands in last stage.
      1. In one example, all the sub-bands of the same level are used.
      2. In one example, only certain sub-bands of the same level are used.

(3) The design of the decoder comprises the following:

Bitstreams corresponding to all subbands might be fed to the entropy decoder to reconstruct the input images. The operation might be designed in one or more of the following approaches:
a. In one example, a gaussian distribution will be used to model the probability of the lossless wavelet sub-bands. Specifically, the mean and/or the variance of the distribution might be obtained based on the aforementioned entropy model:
   i. In one example, to decouple the parsing and entropy probability modeling process, the obtained mean and variance are not only simply used in probability model. Residual value is obtained from the bitstream. Afterwards a mean value is calculated, which is added to the residual value to obtain the latent samples. The latent samples are used by the synthesis transform (e.g. inverse transform, or wavelet like inverse transform) to obtain the reconstructed image.
      2. In one example, the mean value is quantized before adding to the residual value.
         c. In one example, the round function is used in mean value quantization. The quantized value might be the nearest integer of the input value.
         d. In one example, a scale parameter might be applied to the mean value quantization (e.g. before quantization), which can control the step of the quantization adaptively.
      4. In one example, to obtain the sub-bands with different spatial resolutions a hyper decoder subnetwork is utilized.
         a. In one example, the weights of hyper decoder subnetworks that are used in obtaining sub-bands with different resolutions are shared. For example the weight of the hyper decoder subnetwork processing small sub-bands will be reused in the processing of larger sub-bands.
         b. In one example, the weights in hyper decoders are independent. Different weights might be applied to the sub-bands of different spatial resolutions.
      5. In one example, to process multiple sub-bands of different spatial resolutions, context information might be exacted from the sub-bands.
         a. In one example, the context information is obtained according to ŷ (e.g. latent samples), which is obtained by adding quantized mean samples to residual samples.
         b. In one example, the context information is exacted not only from ŷ, but also from the sub-bands.
         i In one example, the context model used for the first sub-band to be encoded (LLD) is a pure pixel-CNN with masked convolution which only utilizes the correlation inside the first sub-band. For other sub-bands, besides using the previously processed coefficients in the same sub-band, the context model also uses the coefficients from the previously processed sub-bands.
         ii In one example, the channel-level auto-regression is added to context model to accelerate the coding process. In the main structure of mixed auto-regressive entropy model, only LL sub-band does pixel-level auto-regression. Meanwhile LL sub-band is the context for HL sub-band, the channel-level auto-regression is applied on LL. Similarly, while processing LH, LL and HL are utilized as context.
   ii. Alternatively, the parsing and entropy probability modeling process are not decoupled. The obtained mean and variance are directly used in probability model.
      2. In one example, to process 13 sub-bands of four different spatial resolutions after four levels of 5/3 wavelet transformation, the hyper decoder needs to be finely designed.
         a. In one example, the weights in hyper decoder are shared, considering that hyper decoder have similar function and operation on different sub-bands. The weight of the block processing small sub-bands will be reused in the processing of larger sub-bands.
         b. In one example, the weights in hyper decoders are independent. Different operation can be applied to the sub-bands of different spatial resolutions.

(4) The design of the decoder comprises the following:

According to the disclosure an indication is included in the bitstream to control the application of lossless mode. In other words, the indication controls whether the lossless mode is enabled or not.

Based on the value of the indication, the quantization of the mean value (prediction value) might be controlled. For example, if the indication is true (i.e. the lossless mode is enabled), the mean value is quantized before adding to residual value. The quantization might be performed according to any method mentioned above. If the indication is false (lossless mode is disabled), the mean value is not quantized before adding to residual value.

A resizing or resampling subnetwork is enabled based on the value of an indication. For example, if the lossless mode is disabled, a resampling NN subnetwork is applied to latent samples before processing with synthesis transform (e.g. inverse transform, or inverse wavelet transform). If the lossless mode is enabled, the resampling NN subnetwork is not applied.
The resampling subnetwork changes the size of the input. For example, the latent samples corresponding to different sub-bands might be input to the resampling subnetwork. The size of the input subbands are modified by the resampling subnetwork.
   In one example the size (width or height) of the subband is increased by the resampling subnetwork.
   In another example the size (width or height) of the subband is reduced by the resampling subnetwork.

The resampling subnetwork might be a downsampling subnetwork or an upsampling subnetwork.

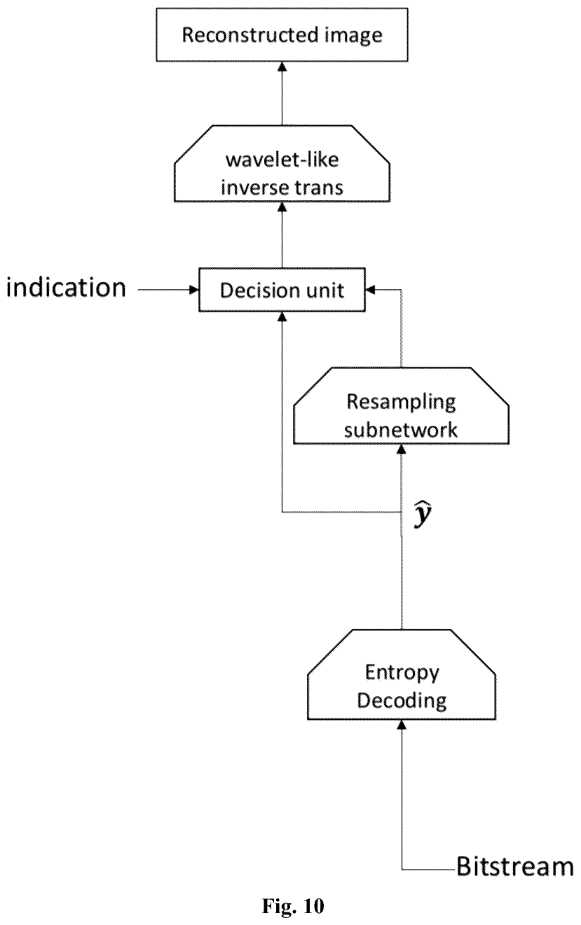

FIG. 10 illustrates an example application of the disclosure. FIG. 10 exemplifies the disclosure. The entropy decoding unit is used to obtain the latent samples ŷ. The latent samples comprise different subbands of the wavelet transform. A resampling network might applied to the subbands of the latent samples according to the value of an indication that is obtained from a bitstream. The indication might control whether the latent samples are used as is or if a resampling subnetwork is applied to the latent samples. For example, if the value of the indication is 0, the latent samples might be used without application of resampling subnetwork, otherwise the resampling subnetwork is applied. The decision unit might be used to select which one of the inputs are used by the inverse transform (either ŷ or the output of resampling subnetwork).

The indication obtained from the bitstream might indicate if a lossless decoding or encoding mode is enabled. If the lossless mode is enabled, the application of resampling network might be detrimental, since resampling typically includes loss of information. The indication is used to disabled application of the resampling subnetwork to make sure lossless processing can be achieved.

### 6. Embodiments

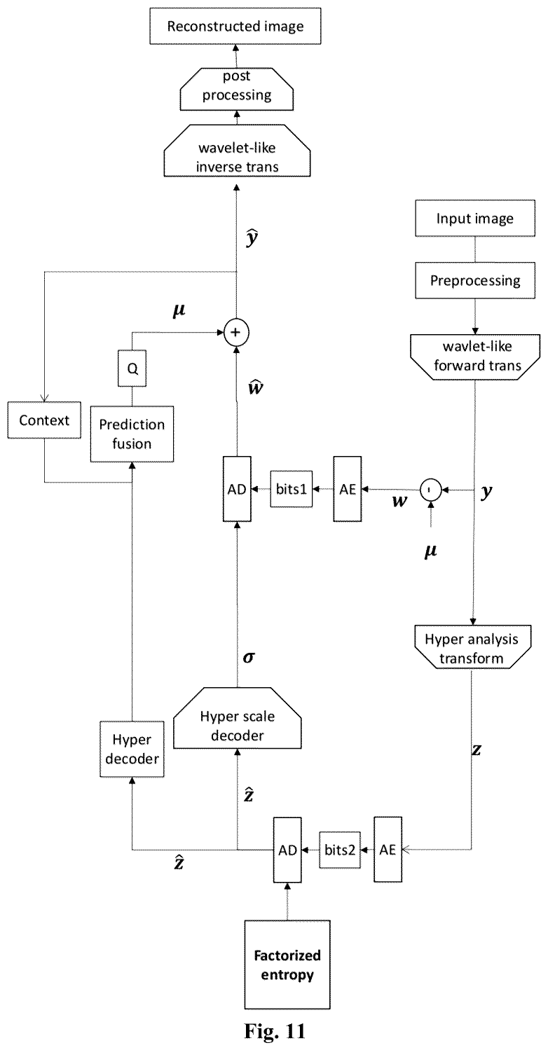

FIG. 11 illustrates an example of the encoding and/or decoding process. Input images are processed by the wavelet-like network and transformed to multiple (for example 13) subbands of different spatial resolutions (e.g. for different resolutions). One or more of the subbands might go through the hyper analysis transformation. The processed latent features are encoded by an entropy encoding module to obtain the bitstream. It is noted that the multiple subbands described above are provided just as an example. The disclosure applies to any wavelet-based transformation, wherein at least two subbands with different sizes are generated as output. The “hyper decoder”, “hyper encoder” and some other modules are also given just as an example, the disclosure applies also to cases to any other neural network that might be applied in entropy coding. A context model might be used for the first subband. The input might firstly be processed by a masked convolution layer with kernel size 3 and go through blocks comprising mask convolution layers and ReLU layer with residual connection. Then several convolution layers and mask convolution might be applied to the input. The “context model” is given just as an example, the disclosure applies also to cases to any other neural network that might be applied in entropy coding.

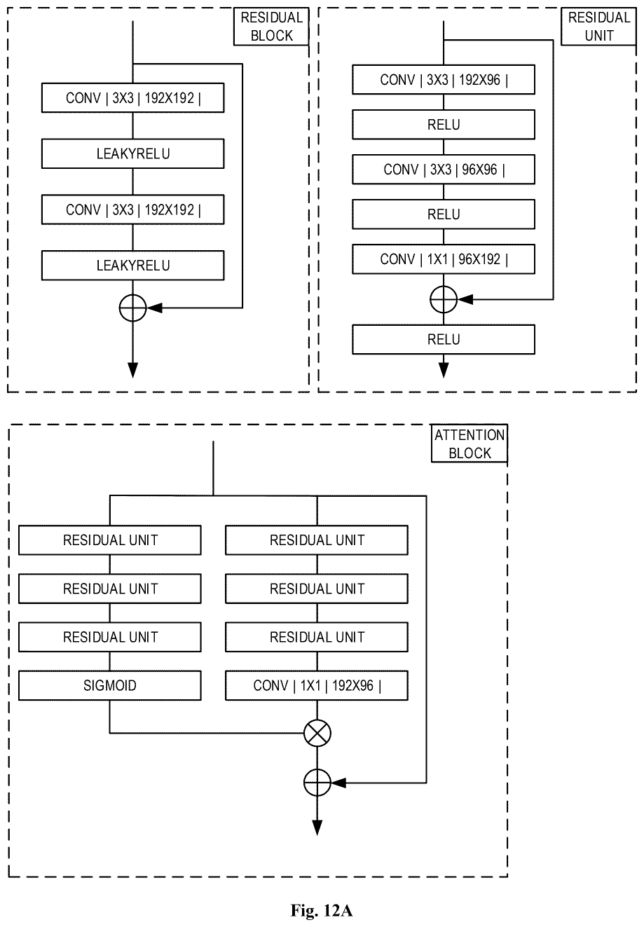

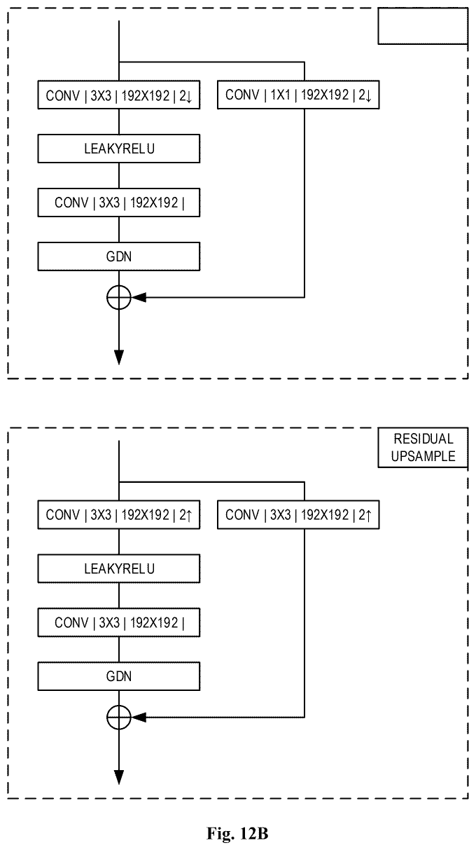

FIGS. 12A-12B illustrate example sub-networks utilized in FIG. 11. FIGS. 12A-12B depict the details of an example attention block, residual downsample block, residual unit, residual block and residual upsample block. These sub-networks might used in hyper analysis transform and hyper decoder. Residual block is composed of convolution layers, leaky ReLU and a residual connection. Based on residual block, residual unit add another ReLU layer to get the final output. Attention block might comprise two branches and a residual connection. Branches have residual unit and convolution layer. Residual downsample block might comprise convolution layer with stride2, leaky ReLU, convolution layer with stride 1, and generalized divisive normalization (GDN). It might also comprise a 2-stride convolution layer in its residual connection. Residual upsample block might comprise convolution layer with stride2, leaky ReLU, convolution layer with stride 1, and inverse generalized divisive normalization (iGDN). It might also comprise a 2-stride convolution layer in its residual connection. The sub-networks are given just as examples, the disclosure applies also to cases to any other neural network that might be applied in entropy coding.

More details of the embodiments of the present disclosure will be described below which are related to neural network-based visual data coding. As used herein, the term “visual data” may refer to a video, an image, a picture in a video, or any other visual data suitable to be coded.

As discussed above, in the existing design for neural network (NN)-based visual data coding based on a wavelet-like transformation, the parameters of the probability distribution is not properly quantized and the context information of different sub-bands is not fully utilized.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

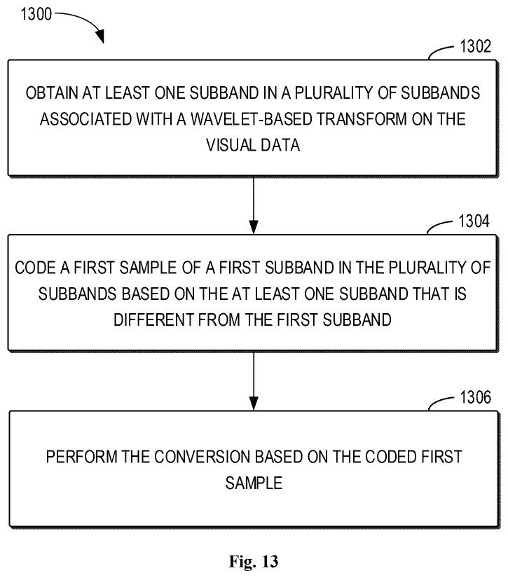

FIG. 13 illustrates a flowchart of a method 1300 for visual data processing in accordance with some embodiments of the present disclosure. The method 1300 may be implemented during a conversion between the visual data and a bitstream of the visual data, which is performed with a neural network (NN)-based model. As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

As shown in FIG. 13, the method 1300 starts at 1302, at least one subband in a plurality of subbands associated with a wavelet-based transform on the visual data is obtained. In some embodiments, the plurality of subbands may be determined by applying a wavelet-based transform (such as a 5/3 wavelet transform, or the like) on the visual data, e.g., at an encoder. As used herein, the wavelet-based transform may also be referred to as a wavelet-like transform or a learning-based wavelet-like transform. At a decoder, the at least one subband may be decoded from the bitstream. In one example, the output of the wavelet-based transform may be of an integer format. A subband that is of an integer format may also be referred to as an integer subband. Alternatively, the output of the wavelet-based transform may be of a floating point format.

In some embodiments, a spatial resolution of one of the at least one subband may be different from a spatial resolution of the first subband. Additionally or alternatively, the at least one subband may comprise all of subbands that may be at the same level as the first subband. With reference to FIG. 9, if the first subband is HH2 subband, the at least one subband may comprise LL2 subband, HL2 subband, and LH2 subband. Alternatively, the at least one subband may comprise one or more specific subbands that are at the same level as the first subband. With reference to FIG. 9, if the first subband is HH2 subband, the at least one subband may only comprise LH2 subband. It should be understood that the above examples are described merely for purpose of description. The scope of the present disclosure is not limited in this respect.

At 1304, a first sample of a first subband in the plurality of subbands is coded based on the at least one subband that is different from the first subband. By way of example rather than limitation, at the encoder, the first sample may be encoded based on context information that is determined based on one or more samples in the at least one subband. Additionally or alternatively, at the decoder the first sample may be decoded (or reconstructed) based on context information that is determined based on one or more samples in the at least one subband. This will be descried in detail below.

At 1306, the conversion is performed based on the coded first sample. By way of example rather than limitation, the first subband may be reconstructed with the coded first sample, and in turn, the visual data may be reconstructed based on the reconstructed first subband. In some embodiments, the conversion may include encoding the visual data into the bitstream. Additionally or alternatively, the conversion may include decoding the visual data from the bitstream. It should be understood that the above illustrations are described merely for purpose of description. The scope of the present disclosure is not limited in this respect.

In view of the above, a subband in a plurality of subbands associated with a wavelet-based transform on the visual data is coded based on at least one further subband in the plurality of subbands. Compared with the conventional solution where each of the plurality of subbands is coded independently, the proposed method can advantageously utilize the cross-subband information, and thus the coding quality can be improved.

In some embodiments, at least one probability distribution may be used to model the plurality of subbands. For example, the at least one probability distribution may be used to model each sample in the plurality of subbands, e.g., the first sample. Alternatively, the at least one probability distribution may be used to model a part of samples in the plurality of subbands, e.g., the first sample. In one example, the at least one probability distribution may comprise a single gaussian distribution. Alternatively, the at least one probability distribution may comprise a gaussian mixture model, which may comprise a plurality of gaussian distributions.

In some embodiments, a mean of the at least one probability distribution may be obtained based on an entropy model comprised in the NN-based model. Additionally or alternatively, a variance of the at least one probability distribution may be obtained based on an entropy model comprised in the NN-based model. It should be noted that the mean and variance are just two example implementations of parameters of the at least one probability distribution. They can be replaced with or used in combination with any other suitable probability parameter, such as standard deviation or the like. The scope of the present disclosure is not limited in this respect.

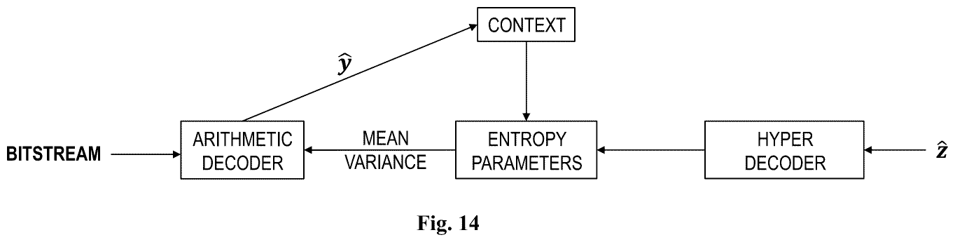

In some embodiments, the proposed method may be applied to a case where a parsing process and an entropy probability modeling process are coupled. In other words, these two processes are not decoupled. In this case, for example, the obtained mean and variance are directly used in a probability model. By way of example rather than limitation, FIG. 14 illustrates an example coding structure for the case where a parsing process and an entropy probability modeling process are coupled. As shown in FIG. 14, the process of reconstructing the latent samples ŷ (which correspond to samples of the subband) is performed as follows:
1. The quantized hyper latent \hat{z} (which is a side information) is processed by hyper decoder to generate first information. The first information is fed to entropy parameters module.
2. The following operations are performed serially and in a recursive manner to reconstruct a sample ŷ[i,j] of the latent samples:
   a. The context model generates second information using the already reconstructed latent samples;
   b. Based on the first and the second information, the entropy parameters module generates the mean μ[i,j] and variance σ[i,j] of a gaussian probability distribution for the sample ŷ[i,j];
   c. Arithmetic decoder decodes the sample ŷ[i,j] from the bitstream using the probability distribution, whose mean and variance are μ[i,j] and σ[i,j].

It is seen that the arithmetic decoding operation and the context model operation form a serial operation for the decoding of ŷ[i,j]. That is, the parsing process and an entropy probability modeling process are coupled.

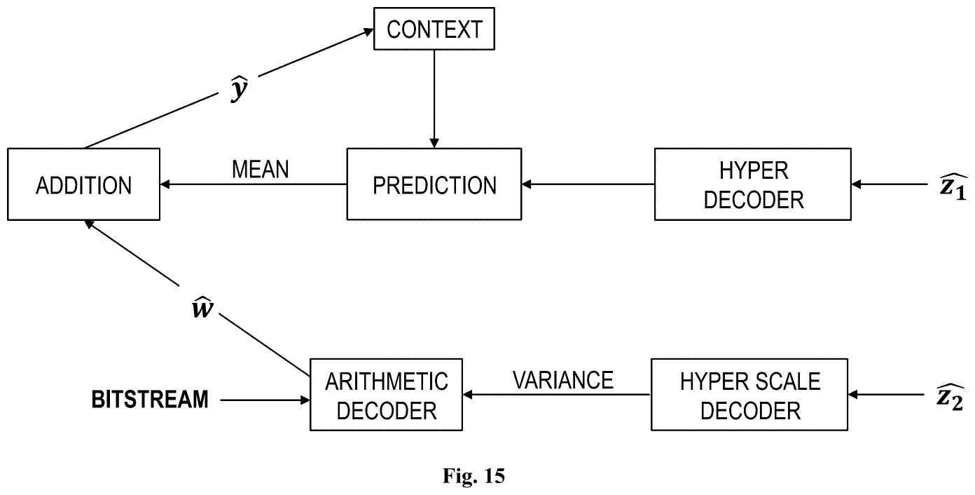

In some alternative embodiments, the proposed method may be applied to a case where a parsing process and an entropy probability modeling process are decoupled. In other words, these two processes are not coupled. In this case, for example, the obtained mean and variance are not directly used in the probability model. By way of example rather than limitation, FIG. 15 illustrates an example coding structure for the case where a parsing process and an entropy probability modeling process are decoupled. As shown in FIG. 14, the process of reconstructing the latent samples ŷ (which correspond to samples of the subband) is performed as follows:
3. Firstly, a hyper scale decoder subnetwork determines a probability parameter (e.g., variance or the like) based on second side information (denoted as [symbol] in FIG. 15).
4. A residual (denoted as ŵ in FIG. 15) is obtained from the bitstream by performing an arithmetic decoding process based on the probability parameter generated by the hyper scale decoder network.
5. The following operations are performed in a loop until all samples of ŷ are obtained:
   a. A prediction subnetwork and a context model are used to determine a mean of a gaussian probability distribution for the sample ŷ[i,j] based on already reconstructed samples and information which is generated by a hyper decoder subnetwork based on first side information (denoted as [symbol] in FIG. 15).
   b. The residual ŵ and the mean are added up to obtain the sample ŷ[i,j].

It is seen that the arithmetic decoding operation and the context model operation are decoupled for decoding latent samples. That is, the parsing process and an entropy probability modeling process are decoupled. Thereby, the entropy coding process is allowed to be performed independently, and thus the coding efficiency can be improved.

In some embodiments, the first side information may be the same as the second side information. Alternatively, the first side information may be different from the second side information. For example, the first side information and the second side information may be comprised in the bitstream. At the encoder side, the side information may be determined based on the band, e.g., with a hyper analysis transform.

In some embodiments, at 1304, a prediction for the first sample may be determined, and a residual for the first sample may be obtained. Moreover, the first sample may be reconstructed based on the prediction and the residual. In one example embodiment, the at least one probability distribution may only comprise a single probability distribution, and the prediction for the first sample may be determined as a mean of the single probability distribution.

In a further example embodiment, the at least one probability distribution may comprise a plurality of probability distributions, and the prediction for the first sample may be determined based on a plurality of means of the plurality of probability distributions. By way of example rather than limitation, the prediction may be determined as an average of the plurality of means or a weighted sum of the plurality of means. For example, weights used for determining the weighted sum of the plurality of means may be derived from an entropy model comprised in the NN-based model. It should be understood that the prediction of for the first sample may also be determined in any other suitable manner. The scope of the present disclosure is not limited in this respect.

In some embodiments, the residual may be obtained from the bitstream based on a variance of the at least one probability distribution, e.g., in aid of an arithmetic decoding process or the like.

In some embodiments, a sum of the prediction and the residual for the first sample is determined to obtain the reconstructed first sample. Alternatively, the prediction for the first sample is quantized, and a sum of the quantized prediction and the residual for the first sample is determined to obtain the reconstructed first sample. By way of example rather than limitation, the prediction for the first sample may be quantized with a round function. For example, the quantization value may be equal to the nearest integer of the input value. In addition, a scale parameter may be applied to the quantization of the prediction for the first sample, so as to control the step of the quantization adaptively.

In some embodiments, whether the prediction for the first sample is quantized before being used to reconstruct the first sample may be dependent on a first indication. By way of example rather than limitation, the first indication may indicate whether a lossless mode (e.g., a lossless coding mode) may be enabled or not. For example, if the first indication indicates that the lossless mode is enabled, the prediction for the first sample may be quantized before being used to reconstruct the first sample. If the first indication indicates that the lossless mode is disabled, the prediction for the first sample may be not quantized before being used to reconstruct the first sample.

In some embodiments, a parsing process and an entropy probability modeling process may be decoupled. Alternatively, the parsing process and the entropy probability modeling process may be not decoupled. In this case, the first sample may be obtained from the bitstream based on a mean and a variance of the at least one probability distribution.

In some embodiments, context information for the first sample may be determined based on reconstructed samples of the first subband. Additionally or alternatively, the context information for the first sample may be determined based on the at least one subband. For example, the context information for the first sample may be determined based on reconstructed samples of the at least one subband.

In some embodiments, in a case where the parsing process and the entropy probability modeling process are decoupled, the context information for the first sample may be used for determining a mean of the at least one probability distribution. In a further case where a parsing process and an entropy probability modeling process are not decoupled, the context information for the first sample may be used for determining a mean and a variance of the at least one probability distribution.

In some embodiments, the NN-based model may comprise a second subnetwork for determining the context information for the first sample. For example, the second subnetwork may be a context model.

By way of example, the context model used for the subband to be encoded at first is a pure pixel-convolutional neural network (CNN) with masked convolution which only utilizes the correlation inside this sub-band. For other sub-bands, besides using the previously processed samples in the same sub-band, the context model may also use the samples from the previously processed sub-bands. This is achieved by introducing a long-term context Lt. For example, when processing HL3 sub-band, LL3 sub-band is used as the long-term context Lt. When processing LH3 sub-band, {LL3 sub-band, HL3 sub-band} are stacked and then used as the long-term context Lt. When processing HH3 sub-band, {LL3 sub-band, HL3 sub-band, LH3 sub-band} are stacked and then used as the long-term context Lt, and so on. Thereby, the cross-subband information may be fully utilized.

In some additional or alternative embodiments, a channel-level auto-regression may be applied at the second subnetwork. For example, in the main structure of mixed auto-regressive entropy model, a pixel-level auto-regression is only applied to LL sub-band. Meanwhile LL sub-band is the context for HL sub-band, the channel-level auto-regression is applied on LL sub-band. Similarly, while processing LH sub-band, LL sub-band and HL sub-band are utilized as context. After finishing one stage, all the sub-bands will be bicubic upsampled and used as the context for sub-bands in last stage.

In some embodiments, the NN-based model may comprise a first subnetwork used to determine at least two subbands in the plurality of subbands, and the at least two subbands may be of different spatial resolutions. By way of example rather than limitation, the first subnetwork may comprise a hyper decoder subnetwork.

In some embodiments, same values of parameters of the first subnetwork may be used for determining the at least two subbands. For example, values of parameters of the first subnetwork that may be used for determining a subband with a first spatial resolution may be reused for determining a further subband with a second spatial resolution larger than the first spatial resolution. In some alternative embodiments, different values of parameters of the first subnetwork may be used for determining the at least two subbands. By way of example, the parameters of the first subnetwork may comprise weights of the first subnetwork.

In some embodiments, at 1306, the first subband may be reconstructed based on the coded first sample. Moreover, a synthesis transform may be applied on the reconstructed first subband. The synthesis transform may be an inverse transform, an inverse wavelet transform, or the like.

In some alternative embodiments, the first subband may be reconstructed based on the coded first sample. The reconstructed first subband is resized and the synthesis transform is applied on the resized first subband. In one example, resizing the reconstructed first subband may comprise increasing a size of the reconstructed first subband. In another example, resizing the reconstructed first subband may comprise reducing the size of the reconstructed first subband.

In some embodiments, the NN-based model may comprise a third subnetwork for resizing the reconstructed first subband. By way of example rather than limitation, the third subnetwork may comprise a downsampling subnetwork or an upsampling subnetwork.

In some embodiments, whether the reconstructed first subband is resized before being processed with the synthesis transform may be dependent on a first indication. For example, the first indication may indicate whether a lossless mode may be enabled or not. By way of example rather than limitation, if the first indication indicates that the lossless mode is enabled, the reconstructed first subband may be not resized before being processed with the synthesis transform. If the first indication indicates that the lossless mode is disabled, the reconstructed first subband may be resized before being processed with the synthesis transform. In addition, the first indication may be indicated in the bitstream.

In some embodiments, in the encoding process, at 1304, a prediction for the first sample may be determined. Moreover, a residual for the first sample may be determined based on the first sample and the prediction for the first sample. The residual may be encoded into the bitstream. In one example embodiment, the at least one probability distribution may only comprise a single probability distribution, and the prediction for the first sample may be determined as a mean of the single probability distribution.

In a further example embodiment, the at least one probability distribution may comprise a plurality of probability distributions, and the prediction for the first sample may be determined based on a plurality of means of the plurality of probability distributions. By way of example rather than limitation, the prediction may be determined as an average of the plurality of means or a weighted sum of the plurality of means. For example, weights used for determining the weighted sum of the plurality of means may be derived from an entropy model comprised in the NN-based model. It should be understood that the prediction of for the first sample may also be determined in any other suitable manner. The scope of the present disclosure is not limited in this respect.

In some embodiments, the prediction for the first sample may be subtracted from the first sample to obtain the residual. Alternatively, the prediction for the first sample may be quantized, and the quantized prediction for the first sample may be subtracted from the first sample to obtain the residual. By way of example, the prediction for the first sample may be quantized with a round function. In addition, a scale parameter may be applied to the quantization of the prediction for the first sample.

In some embodiments, the NN-based model further may comprise a fourth subnetwork for generating side information based on the plurality of subbands. By way of example rather than limitation, the fourth subnetwork may comprise a hyper analysis transformation. In one example embodiment, same values of parameters of the fourth subnetwork may be used for at least two subbands in the plurality of subbands. The at least two subbands are of different spatial resolutions. For example, values of parameters of the fourth subnetwork that may be used for determining a subband with a first spatial resolution may be reused for determining a further subband with a second spatial resolution larger than the first spatial resolution. Alternatively, different values of parameters of the first subnetwork may be used for the at least two subbands in the plurality of subbands.

In view of the above, the solutions in accordance with some embodiments of the present disclosure can advantageously utilize the cross-subband information to enhance the quality of the reconstructed visual data, and thus the coding quality can be improved.

According to further embodiments of the present disclosure, a non-transitory computer-readable recording medium is provided. The non-transitory computer-readable recording medium stores a bitstream of visual data which is generated by a method performed by an apparatus for visual data processing. In the method, at least one subband in a plurality of subbands associated with a wavelet-based transform on the visual data is obtained. A first sample of a first subband in the plurality of subbands is coded based on the at least one subband that is different from the first subband. Moreover, the bitstream is generated with a neural network (NN)-based model based on the coded first sample.

According to still further embodiments of the present disclosure, a method for storing a bitstream of visual data is provided. In the method, at least one subband in a plurality of subbands associated with a wavelet-based transform on the visual data is obtained. A first sample of a first subband in the plurality of subbands is coded based on the at least one subband that is different from the first subband. Moreover, the bitstream is generated with a neural network (NN)-based model based on the coded first sample, and stored in a non-transitory computer-readable recording medium.

Implementations of the present disclosure can be described in view of the following clauses, the features of which can be combined in any reasonable manner.

Clause 1. A method for visual data processing, comprising: obtaining, for a conversion between visual data and a bitstream of the visual data with a neural network (NN)-based model, at least one subband in a plurality of subbands associated with a wavelet-based transform on the visual data; coding a first sample of a first subband in the plurality of subbands based on the at least one subband that is different from the first subband; and performing the conversion based on the coded first sample.

Clause 2. The method of clause 1, wherein at least one probability distribution is used to model the first sample.

Clause 3. The method of clause 2, wherein the at least one probability distribution comprises a gaussian distribution or a gaussian mixture model.

Clause 4. The method of any of clauses 2-3, wherein at least one of a mean or a variance of the at least one probability distribution is obtained based on an entropy model comprised in the NN-based model.

Clause 5. The method of any of clauses 2-4, wherein coding the first sample comprises: determining a prediction for the first sample; obtaining a residual for the first sample; and reconstructing the first sample based on the prediction and the residual.

Clause 6. The method of clause 5, wherein the at least one probability distribution comprises a single probability distribution, and the prediction for the first sample is determined as a mean of the single probability distribution.

Clause 7. The method of clause 5, wherein the at least one probability distribution comprises a plurality of probability distributions, and the prediction for the first sample is determined based on a plurality of means of the plurality of probability distributions.

Clause 8. The method of clause 7, wherein the prediction is determined as an average of the plurality of means or a weighted sum of the plurality of means.

Clause 9. The method of clause 8, wherein weights used for determining the weighted sum of the plurality of means are derived from an entropy model comprised in the NN-based model.

Clause 10. The method of any of clauses 5-9, wherein the residual is obtained from the bitstream based on a variance of the at least one probability distribution.

Clause 11. The method of any of clauses 5-10, wherein reconstructing the first sample comprises: determine a sum of the prediction and the residual for the first sample to obtain the reconstructed first sample.

Clause 12. The method of any of clauses 5-10, wherein reconstructing the first sample comprises: quantizing the prediction for the first sample; and determine a sum of the quantized prediction and the residual for the first sample to obtain the reconstructed first sample.

Clause 13. The method of clause 12, wherein the prediction for the first sample is quantized with a round function.

Clause 14. The method of any of clauses 12-13, wherein a scale parameter is applied to the quantization of the prediction for the first sample.

Clause 15. The method of any of clauses 5-14, wherein whether the prediction for the first sample is quantized before being used to reconstruct the first sample is dependent on a first indication.

Clause 16. The method of clause 15, wherein the first indication indicates whether a lossless mode is enabled or not.

Clause 17. The method of clause 16, wherein if the first indication indicates that the lossless mode is enabled, the prediction for the first sample is quantized before being used to reconstruct the first sample, or if the first indication indicates that the lossless mode is disabled, the prediction for the first sample is not quantized before being used to reconstruct the first sample.

Clause 18. The method of any of clauses 1-17, wherein a parsing process and an entropy probability modeling process are decoupled.

Clause 19. The method of any of clauses 1-4, wherein a parsing process and an entropy probability modeling process are not decoupled.

Clause 20. The method of any of clauses 2-4 and 19, wherein the first sample is obtained from the bitstream based on a mean and a variance of the at least one probability distribution.

Clause 21. The method of any of clauses 1-20, wherein context information for the first sample is determined based on reconstructed samples of the first subband.

Clause 22. The method of any of clauses 1-21, wherein context information for the first sample is determined based on the at least one subband.

Clause 23. The method of any of clauses 1-22, wherein context information for the first sample is determined based on reconstructed samples of the at least one subband.

Clause 24. The method of any of clauses 21-23, wherein if a parsing process and an entropy probability modeling process are decoupled, the context information for the first sample is used for determining a mean of the at least one probability distribution, or if a parsing process and an entropy probability modeling process are not decoupled, the context information for the first sample is used for determining a mean and a variance of the at least one probability distribution.

Clause 25. The method of any of clauses 21-24, wherein the NN-based model comprises a second subnetwork for determining the context information for the first sample.

Clause 26. The method of clause 25, wherein the second subnetwork is a context model.

Clause 27. The method of any of clauses 25-26, wherein a channel-level auto-regression is applied at the second subnetwork.

Clause 28. The method of any of clauses 1-27, wherein the NN-based model comprises a first subnetwork used to determine at least two subbands in the plurality of subbands, and the at least two subbands are of different spatial resolutions.

Clause 29. The method of clause 28, wherein the first subnetwork comprises a hyper decoder subnetwork.

Clause 30. The method of any of clauses 28-29, wherein same values of parameters of the first subnetwork are used for determining the at least two subbands.

Clause 31. The method of clause 30, wherein values of parameters of the first subnetwork that are used for determining a subband with a first spatial resolution are reused for determining a further subband with a second spatial resolution larger than the first spatial resolution.

Clause 32. The method of any of clauses 28-29, wherein different values of parameters of the first subnetwork are used for determining the at least two subbands.

Clause 33. The method of any of clauses 30-32, wherein the parameters of the first subnetwork comprises weights of the first subnetwork.

Clause 34. The method of any of clauses 1-33, wherein the conversion includes decoding the visual data from the bitstream.

Clause 35. The method of clause 34, wherein performing the conversion comprises: reconstructing the first subband based on the coded first sample; and applying a synthesis transform on the reconstructed first subband.

Clause 36. The method of clause 34, wherein performing the conversion comprises: reconstructing the first subband based on the coded first sample; resizing the reconstructed first subband; and applying a synthesis transform on the resized first subband.

Clause 37. The method of clause 36, wherein resizing the reconstructed first subband comprises: increasing a size of the reconstructed first subband, or reducing the size of the reconstructed first subband.

Clause 38. The method of any of clauses 36-37, wherein the NN-based model comprises a third subnetwork for resizing the reconstructed first subband.

Clause 39. The method of clause 38, wherein the third subnetwork comprises a downsampling subnetwork or an upsampling subnetwork.

Clause 40. The method of any of clauses 35-39, wherein whether the reconstructed first subband is resized before being processed with the synthesis transform is dependent on a first indication.

Clause 41. The method of clause 40, wherein the first indication indicates whether a lossless mode is enabled or not.

Clause 42. The method of clause 41, wherein if the first indication indicates that the lossless mode is enabled, the reconstructed first subband is not resized before being processed with the synthesis transform, or if the first indication indicates that the lossless mode is disabled, the reconstructed first subband is resized before being processed with the synthesis transform.

Clause 43. The method of any of clauses 15-17 and 40-42, wherein the first indication is indicated in the bitstream.

Clause 44. The method of any of clauses 1-33, wherein the conversion includes encoding the visual data into the bitstream.

Clause 45. The method of clause 44, wherein coding the first sample comprises: determining a prediction for the first sample; determining a residual for the first sample based on the first sample and the prediction for the first sample; and encoding the residual into the bitstream.

Clause 46. The method of clause 45, wherein the at least one probability distribution comprises a single probability distribution, and the prediction for the first sample is determined as a mean of the single probability distribution.

Clause 47. The method of clause 45, wherein the at least one probability distribution comprises a plurality of probability distributions, and the prediction for the first sample is determined based on a plurality of means of the plurality of probability distributions.

Clause 48. The method of clause 47, wherein the prediction is determined as an average of the plurality of means or a weighted sum of the plurality of means.

Clause 49. The method of clause 48, wherein weights used for determining the weighted sum of the plurality of means are derived from an entropy model comprised in the NN-based model.

Clause 50. The method of any of clauses 45-49, wherein determining the residual for the first sample comprises: subtracting the prediction for the first sample from the first sample to obtain the residual.

Clause 51. The method of any of clauses 45-49, wherein determining the residual for the first sample comprises: quantizing the prediction for the first sample; and subtracting the quantized prediction for the first sample from the first sample to obtain the residual.

Clause 52. The method of clause 51, wherein the prediction for the first sample is quantized with a round function.

Clause 53. The method of any of clauses 51-52, wherein a scale parameter is applied to the quantization of the prediction for the first sample.

Clause 54. The method of any of clauses 44-53, wherein the NN-based model further comprises a fourth subnetwork for generating side information based on the plurality of subbands.

Clause 55. The method of clause 54, wherein the fourth subnetwork comprises a hyper analysis transformation.

Clause 56. The method of any of clauses 54-55, wherein same values of parameters of the fourth subnetwork are used for at least two subbands in the plurality of subbands, and the at least two subbands are of different spatial resolutions.

Clause 57. The method of clause 56, wherein values of parameters of the fourth subnetwork that are used for determining a subband with a first spatial resolution are reused for determining a further subband with a second spatial resolution larger than the first spatial resolution.

Clause 58. The method of any of clauses 54-55, wherein different values of parameters of the first subnetwork are used for at least two subbands in the plurality of subbands, and the at least two subbands are of different spatial resolutions.

Clause 59. The method of any of clauses 1-58, wherein a spatial resolution of one of the at least one subband is different from a spatial resolution of the first subband.

Clause 60. The method of any of clauses 1-59, wherein the at least one subband comprises all of subbands that are at the same level as the first subband.

Clause 61. The method of any of clauses 1-60, wherein the at least one subband comprises one or more subbands that are at the same level as the first subband.

Clause 62. The method of any of clauses 1-61, wherein the visual data comprise a video, a picture of the video, or an image.

Clause 63. An apparatus for visual data processing comprising a processor and a non-transitory memory with instructions thereon, wherein the instructions upon execution by the processor, cause the processor to perform a method in accordance with any of clauses 1-62.

Clause 64. A non-transitory computer-readable storage medium storing instructions that cause a processor to perform a method in accordance with any of clauses 1-62.

Clause 65. A non-transitory computer-readable recording medium storing a bitstream of visual data which is generated by a method performed by an apparatus for visual data processing, wherein the method comprises: obtaining at least one subband in a plurality of subbands associated with a wavelet-based transform on the visual data; coding a first sample of a first subband in the plurality of subbands based on the at least one subband that is different from the first subband; and generating the bitstream with a neural network (NN)-based model based on the coded first sample.

Clause 66. A method for storing a bitstream of visual data, comprising: obtaining at least one subband in a plurality of subbands associated with a wavelet-based transform on the visual data; coding a first sample of a first subband in the plurality of subbands based on the at least one subband that is different from the first subband; generating the bitstream with a neural network (NN)-based model based on the coded first sample; and storing the bitstream in a non-transitory computer-readable recording medium.

### EXAMPLE DEVICE

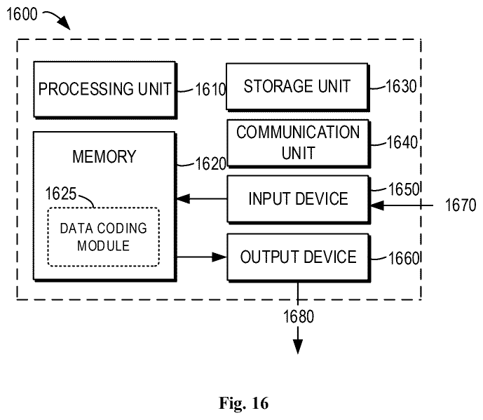

FIG. 16 illustrates a block diagram of a computing device 1600 in which various embodiments of the present disclosure can be implemented. The computing device 1600 may be implemented as or included in the source device 110 (or the visual data encoder 114) or the destination device 120 (or the visual data decoder 124).

FIG. 16 illustrates a block diagram of a computing device 1600 in which various embodiments of the present disclosure can be implemented. The computing device 1600 may be implemented as or included in the source device 110 (or the visual data encoder 114) or the destination device 120 (or the visual data decoder 124).

It would be appreciated that the computing device 1600 shown in FIG. 16 is merely for purpose of illustration, without suggesting any limitation to the functions and scopes of the embodiments of the present disclosure in any manner.

As shown in FIG. 16, the computing device 1600 includes a general-purpose computing device 1600. The computing device 1600 may at least comprise one or more processors or processing units 1610, a memory 1620, a storage unit 1630, one or more communication units 1640, one or more input devices 1650, and one or more output devices 1660.

In some embodiments, the computing device 1600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1600 can support any type of interface to a user (such as “wearable” circuitry and the like).

The processing unit 1610 may be a physical or virtual processor and can implement various processes based on programs stored in the memory 1620. In a multi-processor system, multiple processing units execute computer executable instructions in parallel so as to improve the parallel processing capability of the computing device 1600. The processing unit 1610 may also be referred to as a central processing unit (CPU), a microprocessor, a controller or a microcontroller.

The computing device 1600 typically includes various computer storage medium. Such medium can be any medium accessible by the computing device 1600, including, but not limited to, volatile and non-volatile medium, or detachable and non-detachable medium. The memory 1620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1630 may be any detachable or non-detachable medium and may include a machine-readable medium such as a memory, flash memory drive, magnetic disk or another other media, which can be used for storing information and/or visual data and can be accessed in the computing device 1600.

The computing device 1600 may further include additional detachable/non-detachable, volatile/non-volatile memory medium. Although not shown in FIG. 16, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1640 communicates with a further computing device via the communication medium. In addition, the functions of the components in the computing device 1600 can be implemented by a single computing cluster or multiple computing machines that can communicate via communication connections. Therefore, the computing device 1600 can operate in a networked environment using a logical connection with one or more other servers, networked personal computers (PCs) or further general network nodes.

The input device 1650 may be one or more of a variety of input devices, such as a mouse, keyboard, tracking ball, voice-input device, and the like. The output device 1660 may be one or more of a variety of output devices, such as a display, loudspeaker, printer, and the like. By means of the communication unit 1640, the computing device 1600 can further communicate with one or more external devices (not shown) such as the storage devices and display device, with one or more devices enabling the user to interact with the computing device 1600, or any devices (such as a network card, a modem and the like) enabling the computing device 1600 to communicate with one or more other computing devices, if required. Such communication can be performed via input/output (I/O) interfaces (not shown).

In some embodiments, instead of being integrated in a single device, some or all components of the computing device 1600 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1600 may be used to implement visual data encoding/decoding in embodiments of the present disclosure. The memory 1620 may include one or more visual data coding modules 1625 having one or more program instructions. These modules are accessible and executable by the processing unit 1610 to perform the functionalities of the various embodiments described herein.

In the example embodiments of performing visual data encoding, the input device 1650 may receive visual data as an input 1670 to be encoded. The visual data may be processed, for example, by the visual data coding module 1625, to generate an encoded bitstream. The encoded bitstream may be provided via the output device 1660 as an output 1680.

In the example embodiments of performing visual data decoding, the input device 1650 may receive an encoded bitstream as the input 1670. The encoded bitstream may be processed, for example, by the visual data coding module 1625, to generate decoded visual data. The decoded visual data may be provided via the output device 1660 as the output 1680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
obtaining, for a conversion between visual data and a bitstream of the visual data with a neural network (NN)-based model, at least one subband in a plurality of subbands associated with a wavelet-based transform on the visual data;
coding a first sample of a first subband in the plurality of subbands based on the at least one subband that is different from the first subband; and
performing the conversion based on the coded first sample.

2. The method of claim 1, wherein at least one probability distribution is used to model the first sample.

3. The method of claim 2, wherein coding the first sample comprises:
determining a prediction for the first sample;
obtaining a residual for the first sample; and
reconstructing the first sample based on the prediction and the residual.

4. The method of claim 3, wherein the at least one probability distribution comprises a single probability distribution, and the prediction for the first sample is determined as a mean of the single probability distribution, or
wherein the at least one probability distribution comprises a plurality of probability distributions, and the prediction for the first sample is determined based on a plurality of means of the plurality of probability distributions.

5. The method of claim 4, wherein the prediction is determined as an average of the plurality of means or a weighted sum of the plurality of means, and weights used for determining the weighted sum of the plurality of means are derived from an entropy model comprised in the NN-based model.

6. The method of claim 3, wherein the residual is obtained from the bitstream based on a variance of the at least one probability distribution, or
wherein reconstructing the first sample comprises: determine a sum of the prediction and the residual for the first sample to obtain the reconstructed first sample, or
wherein reconstructing the first sample comprises: quantizing the prediction for the first sample; and determine a sum of the quantized prediction and the residual for the first sample to obtain the reconstructed first sample, or
wherein whether the prediction for the first sample is quantized before being used to reconstruct the first sample is dependent on a first indication.

7. The method of claim 1, wherein context information for the first sample is determined based on reconstructed samples of the first subband, or
wherein context information for the first sample is determined based on the at least one subband, or
wherein context information for the first sample is determined based on reconstructed samples of the at least one subband.

8. The method of claim 7, wherein if a parsing process and an entropy probability modeling process are decoupled, the context information for the first sample is used for determining a mean of the at least one probability distribution, or if a parsing process and an entropy probability modeling process are not decoupled, the context information for the first sample is used for determining a mean and a variance of the at least one probability distribution, or
wherein the NN-based model comprises a second subnetwork for determining the context information for the first sample.

9. The method of claim 1, wherein the NN-based model comprises a first subnetwork used to determine at least two subbands in the plurality of subbands, and the at least two subbands are of different spatial resolutions.

10. The method of claim 9, wherein the first subnetwork comprises a hyper decoder subnetwork, or
wherein same values of parameters of the first subnetwork are used for determining the at least two subbands, and values of parameters of the first subnetwork that are used for determining a subband with a first spatial resolution are reused for determining a further subband with a second spatial resolution larger than the first spatial resolution, or
wherein different values of parameters of the first subnetwork are used for determining the at least two subbands.

11. The method of claim 1, wherein the conversion includes decoding the visual data from the bitstream.

12. The method of claim 11, wherein performing the conversion comprises: reconstructing the first subband based on the coded first sample; and applying a synthesis transform on the reconstructed first subband, or
wherein performing the conversion comprises: reconstructing the first subband based on the coded first sample; resizing the reconstructed first subband; and applying a synthesis transform on the resized first subband.

13. The method of claim 12, wherein resizing the reconstructed first subband comprises: increasing a size of the reconstructed first subband, or reducing the size of the reconstructed first subband, or
wherein the NN-based model comprises a third subnetwork for resizing the reconstructed first subband, or
wherein whether the reconstructed first subband is resized before being processed with the synthesis transform is dependent on a first indication.

14. The method of claim 1, wherein the conversion includes encoding the visual data into the bitstream.

15. The method of claim 14, wherein coding the first sample comprises:
determining a prediction for the first sample;
determining a residual for the first sample based on the first sample and the prediction for the first sample; and
encoding the residual into the bitstream.

16. The method of claim 15, wherein the at least one probability distribution comprises a single probability distribution, and the prediction for the first sample is determined as a mean of the single probability distribution, or
wherein the at least one probability distribution comprises a plurality of probability distributions, and the prediction for the first sample is determined based on a plurality of means of the plurality of probability distributions, or
wherein determining the residual for the first sample comprises: subtracting the prediction for the first sample from the first sample to obtain the residual, or
wherein determining the residual for the first sample comprises: quantizing the prediction for the first sample; and subtracting the quantized prediction for the first sample from the first sample to obtain the residual.

17. The method of claim 1, wherein a spatial resolution of one of the at least one subband is different from a spatial resolution of the first subband, or
wherein the at least one subband comprises all of subbands that are at the same level as the first subband, or
wherein the at least one subband comprises one or more subbands that are at the same level as the first subband, or
wherein the visual data comprise a video, a picture of the video, or an image.

18. An apparatus for visual data processing comprising a processor and a non-transitory memory with instructions thereon, wherein the instructions upon execution by the processor, cause the processor to perform acts comprising:
obtaining, for a conversion between visual data and a bitstream of the visual data with a neural network (NN)-based model, at least one subband in a plurality of subbands associated with a wavelet-based transform on the visual data;
coding a first sample of a first subband in the plurality of subbands based on the at least one subband that is different from the first subband; and
performing the conversion based on the coded first sample.

19. A non-transitory computer-readable storage medium storing instructions that cause a processor to perform acts comprising:
obtaining, for a conversion between visual data and a bitstream of the visual data with a neural network (NN)-based model, at least one subband in a plurality of subbands associated with a wavelet-based transform on the visual data;
coding a first sample of a first subband in the plurality of subbands based on the at least one subband that is different from the first subband; and
performing the conversion based on the coded first sample.

20. A non-transitory computer-readable recording medium storing a bitstream of visual data which is generated by a method performed by an apparatus for visual data processing, wherein the method comprises:
obtaining at least one subband in a plurality of subbands associated with a wavelet-based transform on the visual data;
coding a first sample of a first subband in the plurality of subbands based on the at least one subband that is different from the first subband; and
generating the bitstream with a neural network (NN)-based model based on the coded first sample.
